(19) United States
(12) Patent Application Publication
(10) Pub. No.: US 2024/0287334 A1
(43) Pub. Date: Aug. 29, 2024

(54) INKJET INK

(71) Applicant: KYOCERA Document Solutions Inc., Osaka (JP)

(72) Inventor: Satoshi SATO, Osaka-shi (JP)

(73) Assignee: KYOCERA Document Solutions Inc., Osaka (JP)

(21) Appl. No.: 18/172,964

(22) Filed: Feb. 22, 2023

(51) Int. Cl. C09D 11/326; C09D 11/033; C09D 11/037; C09D 11/107

(52) U.S. Cl. CPC C09D 11/326; C09D 11/033; C09D 11/037; C09D 11/107

(57) ABSTRACT

An inkjet ink contains pigment particles and water. The pigment particles contain a pigment and a specific resin. The specific resin includes a first repeating unit derived from a specific monomer. The specific monomer is nonionic and has a group represented by general formula (A) or (B) below.

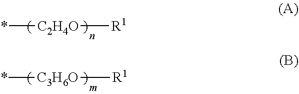

Of all repeating units included in the specific resin, the first repeating unit has a percentage content of at least 0.5% by mass and no greater than 11% by mass. In general formulas (A) and (B), R¹ represents a hydrogen atom or an alkyl group with a carbon number of at least 1 and no greater than 5. n and m each represent, independently of one another, a number of at least 3 and no greater than 9. * represents a bond.

### BACKGROUND

The present disclosure relates to an inkjet ink.

It is required for inkjet inks used in inkjet recording apparatuses to have excellent preservation stability and moderate viscosity, to be able to form images with desired image density, and to inhibit occurrence of nozzle clogging.

To address requirements as above, an inkjet ink is proposed for example that contains water, a water-soluble organic solvent, a coated colorant, and a resin emulsion. The above inkjet ink is said to be able to inhibit occurrence of nozzle clogging.

### SUMMARY

An inkjet ink according to an aspect of the present disclosure contains pigment particles and water. The pigment particles contain a pigment and a specific resin. The specific resin includes a first repeating unit derived from a specific monomer. The specific monomer is nonionic and has a group represented by general formula (A) or (B) below. Of all repeating units included in the specific resin, the first repeating unit has a percentage content of at least 0.5% by mass and no greater than 11% by mass.

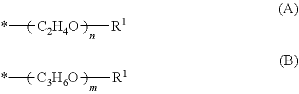

In the general formulas (A) and (B), R¹ represents a hydrogen atom or an alkyl group with a carbon number of at least 1 and no greater than 5. n and m each represent, independently of one another, a number of at least 3 and no greater than 9. * represents a bond.

### DETAILED DESCRIPTION

The following describes an embodiment of the present disclosure. Note that in the following, measurement values for 10% cumulative volume particle diameter (D₁₀), 50% cumulative volume particle diameter (D₅₀), and 90% cumulative volume particle diameter (D₉₀) are values as measured using a dynamic light scattering particle size distribution analyzer (“ZETASIZER NANO ZS”, product of Malvern Instruments Ltd.) unless otherwise stated.

In the following, measurement values for mass average molecular weight (Mw) are values as measured using a gel permeation chromatography unless otherwise stated.

In the present specification, the term “(meth)acryl” is used as a generic term for both acryl and methacryl.

### <Ink>

The following describes an inkjet ink (also referred to below simply as ink) according to an embodiment of the present disclosure. The ink of the present disclosure contains pigment particles and water. The pigment particles contain a pigment and a specific resin. The specific resin includes a first repeating unit derived from a specific monomer. The specific monomer is nonionic and has a group represented by general formula (A) or (B) below. Of all repeating units included in the specific resin, the first repeating unit has a percentage content of at least 0.5% by mass and no greater than 11% by mass.

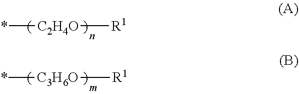

In general formulas (A) and (B), R¹ represents a hydrogen atom or an alkyl group with a carbon number of at least 1 and no greater than 5. n and m each represent, independently of one another, a number of at least 3 and no greater than 9. * represents a bond.

Where the specific resin has a plurality of groups (also referred to below as groups (A)) represented by general formula (A), n in general formula (A) represents an average value of the numbers of repeats of “—C₂H₄O—” in the respective groups (A) that the specific resin has. That is, n corresponds to an average number of moles added of ethylene oxide in a polyethylene oxide structure present in the first repeating unit included in the specific resin. Likewise, where the specific resin has a plurality of groups (also referred to below as groups (B)) represented by general formula (B), m in general formula (B) represents an average value of the numbers of repeats of “—C₃H₆O—” in the respective groups (B) included in the specific resin. That is, m corresponds to an average number of moles added of polypropylene oxide in a polypropylene oxide structure present in the first repeating unit included in the specific resin. Therefore, n and m may each be an integer or a decimal.

No particular limitations are placed on the use of the ink of the present disclosure, and the ink of the present disclosure is favorably used as an ink for use in an inkjet recording apparatus including a line head.

As a result of having the above features, the ink of the present disclosure has excellent preservation stability and moderate viscosity, can form images with desired image density and inhibition of occurrence of nozzle clogging. The reasons therefor are presumed as follows. The ink of the present disclosure contains pigment particles containing a pigment and a specific resin. The specific resin includes the repeating unit having the group (A) or the group (B) that is moderately hydrophilic. With the above feature, the specific resin can have moderately high hydrophilicity so as to stably disperse the pigment particles in the ink. Furthermore, as a result of the first repeating unit being derived from the specific monomer that is nonionic, the specific resin can further stably disperse the pigment particles in the ink. As a result, the ink of the present disclosure can have excellent preservation stability and moderate viscosity and can inhibit occurrence of nozzle clogging. By contrast, in a case in which the resin contained in the pigment particles is excessively hydrophilic, the pigment particles tend to permeate inside a recording medium together with a solvent once the ink lands on the recording medium, leading to a decrease in image density. However, in the ink of the present disclosure, the specific resin is moderately hydrophilic because the first repeating unit has a percentage content of at least 0.5% by mass and no greater than 11% by mass and n for the group (A) or m for the group (B) is a number of at least 3 and no greater than 9. Therefore, the ink of the present disclosure can form images with desired image density.

The ink of the present disclosure will be described further in detail below. Note that each component described below may be used independently or two or more types thereof may be used in combination.

### [Pigment Particles]

The pigment particles each include a core containing a pigment and the specific resin covering the core. The pigment particles are present in a solvent in a dispersed manner, for example.

In dynamic light scattering particle diameter distribution measurement, the pigment particles have a D₁₀ of preferably at least 50 nm and no greater than 80 nm, and more preferably at least 55 nm and no greater than 70 nm. As a result of the D₁₀ of the pigment particles being set to at least 50 nm, the ink of the present disclosure can have further favorable preservation stability and can further easily form images with desired image density. As a result of the D₁₀ of the pigment particles being set to no greater than 80 nm, an excessive increase in later-described D₉₀ can be suppressed.

In dynamic light scattering particle diameter distribution measurement, the pigment particles have a D₅₀ of preferably at least 80 nm and no greater than 130 nm, and more preferably at least 85 nm and no greater than 110 nm. As a result of the D₅₀ of the pigment particles being set to at least 80 nm, the ink of the present disclosure can have further favorable preservation stability and can further easily form images with desired image density. As a result of the D₅₀ of the pigment particles being set to no greater than 130 nm, an excessive increase in later-described D₉₀ can be suppressed.

In dynamic light scattering particle diameter distribution measurement, pigment particles have a D₉₀ of preferably at least 150 nm and no greater than 250 nm, and more preferably at least 170 nm and no greater than 210 nm. As a result of the D₉₀ of the pigment particles being set to at least 150 nm, the ink of the present disclosure can have further favorable preservation stability. As a result of the D₉₀ of the pigment particles being set to no greater than 210 nm, the ink of the present disclosure can further effectively inhibit occurrence of nozzle clogging.

### (Pigment)

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, specifically, 15:3). Examples of the violet pigments include C.I. Pigment Violet (19, 23, or 33). Examples of the black pigments include C.I. Pigment Black (7).

The pigment has a percentage content of preferably at least 2.0% by mass and no greater than 15.0% by mass in the ink of the present disclosure, and more preferably at least 4.0% by mass and no greater than 8.0% by mass. As a result of the percentage content of the pigment being set to at least 2.0% by mass, the ink of the present disclosure can further easily form images with desired image density. As a result of the percentage content of the pigment being set to no greater than 15.0% by mass, ejection stability of the ink of the present disclosure can be ensured.

### (Specific Resin)

The specific resin is water soluble and can inhibit agglomeration of the pigment by attaching to the surface of the pigment. The specific resin includes the first repeating unit derived from the specific monomer.

The specific resin has a percentage content of preferably at least 0.5% by mass and no greater than 10.0% by mass in the ink of the present disclosure, and more preferably at least 2.0% by mass and no greater than 6.0% by mass. As a result of the percentage content of the specific resin being set to at least 0.5% by mass, the ink of the present disclosure can have further favorable preservation stability. As a result of the percentage content of the specific resin being set to no greater than 10.0% by mass, the ink of the present disclosure can further effectively inhibit occurrence of nozzle clogging.

The specific resin has a mass average molecular weight of preferably at least 10,000 and no greater than 50,000, and more preferably at least 15,000 and no greater than 30,000. As a result of the mass average molecular weight of the specific resin being set to at least 10,000 and no greater than 50,000, images with desired image density can be further easily formed while an increase in viscosity of the ink of the present disclosure can be suppressed.

The mass average molecular weight of the specific resin can be adjusted by changing polymerization conditions (e.g., the amount of a polymerization initiator used, polymerization temperature, and polymerization time) for the specific resin.

### (Specific Monomer)

The specific monomer is nonionic and has a group (group (A) or group (B)) represented by general formula (A) or (B) below.

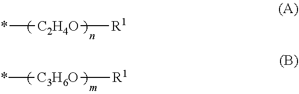

In general formulas (A) and (B), R¹ represents a hydrogen atom or an alkyl group with a carbon number of at least 1 and no greater than 5. n and m each represent, independently of one another, a number of at least 3 and no greater than 9. * represents a bond.

Preferably, n and m each represent a number of at least 3 and no greater than 5.

Examples of the alkyl group with a carbon number of at least 1 and no greater than 5 represented by R¹ include a methyl group, an ethyl group, an n-propyl group, and an i-propyl group. Preferably, R¹ represents a hydrogen atom or a methyl group. As a result of R¹ representing a hydrogen atom or an alkyl group with a relatively small carbon number, the ink of the present disclosure can have moderate viscosity.

Examples of the specific monomer include polyethylene glycol (meth)acrylate and polypropylene glycol (meth)acrylate. Polyethylene glycol (meth)acrylate is a compound represented by the following general formula (1). Polypropylene glycol (meth)acrylate is a compound represented by the following general formula (2). In general formulas (1) and (2) below, R¹, n, and m are the same as defined for those in general formulas (A) and (B). R² represents a hydrogen atom or a methyl group.

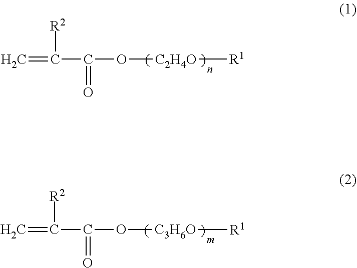

The percentage content of the first repeating unit to all repeating units in the specific resin is at least 0.5% by mass and no greater than 11% by mass, preferably at least 3% by mass and no greater than 9% by mass, and more preferably at least 4% by mass and no greater than 6% by mass. As a result of the percentage content of the first repeating unit being set to at least 0.5% by mass, the ink of the present disclosure can exhibit excellent preservation stability and can inhibit occurrence of nozzle clogging. As a result of the percentage content of the first repeating unit being set to no greater than 11% by mass, the ink of the present disclosure can form images with desired image density.

### (Second Repeating Unit)

Preferably, the specific resin further includes a second repeating unit derived from (meth)acrylic acid. The percentage content of the second repeating unit to all the repeating units in the specific resin is preferably at least 10% by mass and no greater than 60% by mass, more preferably at least 25% by mass and no greater than 45% by mass, and further preferably at least 30% by mass and no greater than 40% by mass. As a result of the percentage content of the second repeating unit being set to at least 10% by mass and no greater than 60% by mass, the ink of the present disclosure can have further favorable preservation stability.

### (Styrene Unit)

Preferably, the specific resin further includes a styrene unit. The percentage content of the styrene unit to all the repeating units in the specific resin is preferably at least 30% by mass and no greater than 85% by mass, more preferably at least 40% by mass and no greater than 80% by mass, and further preferably at least 50% by mass and no greater than 75% by mass. As a result of the percentage content of the styrene unit being set to at least 30% by mass and no greater than 80% by mass, the ink of the present disclosure can have further favorable preservation stability.

### (Additional Repeating Unit)

The specific resin may further include an additional repeating unit other than the first repeating unit, the second repeating unit, and the styrene unit. Examples of the additional repeating unit include a repeating unit derived from (meth)acrylic acid alkyl ester and a repeating unit derived from a nitrogen-containing vinyl compound. Examples of the nitrogen-containing vinyl compound include a quaternary ammonium compound and a vinyl pyridine compound (specifically, N-vinyl pyridine). The additional repeating unit is preferably a repeating unit derived from N-vinyl pyridine.

In a case in which the specific resin includes the additional repeating unit, the percentage content of the additional repeating unit to all the repeating units in the specific resin is preferably at least 0.5% by mass and no greater than 10% by mass, and more preferably at least 2.0% by mass and no greater than 6.0% by mass.

### [Water]

The ink of the present disclosure contains water as a solvent. The percentage content of the water in the ink of the present disclosure is preferably at least 35.0% by mass and no greater than 85.0% by mass, and more preferably at least 50.0% by mass and no greater than 75.0% by mass.

### [Water-Soluble Organic Solvent]

Preferably, the ink of the present disclosure further contains a water-soluble organic solvent. Examples of the water-soluble organic solvent include glycol compounds, glycol ether compounds, lactam compounds, nitrogen-containing compounds, acetate compounds, thiodiglycol, glycerin, and dimethyl sulfoxide.

Examples of the glycol compounds include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol. A preferable glycol compound is 3-methyl-1,5-pentanediol, 1,2-octanediol, 1,3-propanediol, or 1,5-pentanediol.

Examples of the glycol ether compounds include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol dethyl ether, triethylene glycol monomethyl ether, triethylene glycol monoethyl ether, triethylene glycol monobutyl ether, and propylene glycol monomethyl ether. A preferable glycol ether compound is triethylene glycol monobutyl ether.

Examples of the lactam compounds include 2-pyrrolidone and N-methyl-2-pyrrolidone. A preferable lactam compound is 2-pyrrolidone.

The water-soluble organic solvent is preferably a glycol compound, a glycol ether compound, glycerin, or a lactam compound.

The percentage content of the water-soluble organic solvent in the ink of the present disclosure is preferably at least 10.0% by mass and no greater than 45.0% by mass, and more preferably at least 20.0% by mass and no greater than 30.0% by mass.

The percentage content of the glycol compound in the ink of the present disclosure is preferably at least 5.0% by mass and no greater than 25.0% by mass, and more preferably at least 10.0% by mass and no greater than 20.0% by mass.

The percentage content of the glycol ether compound in the ink of the present disclosure is preferably at least 2.0% by mass and no greater than 15.0% by mass, and more preferably at least 4.0% by mass and no greater than 8.0% by mass.

The percentage content of glycerin in the ink of the present disclosure is preferably at least 1.0% by mass and no greater than 10.0% by mass, and more preferably at least 3.0% by mass and no greater than 7.0% by mass.

The percentage content of the lactam compound in the ink of the present disclosure is preferably at least 0.2% by mass and no greater than 4.0% by mass, and more preferably at least 0.8% by mass and no greater than 2.0% by mass.

### [Sugar Alcohol]

From the viewpoint of further effective inhibition of occurrence of nozzle clogging, preferably, the ink of the present disclosure further contains a sugar alcohol. Examples of the sugar alcohol include sorbitol, mannitol, isitol, D-taritol, galactitol, allitol, xylitol, ribitol, arabitol, erythritol, threitol, volemitol, and perseitol. The sugar alcohol is preferably sorbitol.

The percentage content of the sugar alcohol in the ink of the present disclosure is preferably at least 0.01% by mass and no greater than 1.0% by mass, and more preferably at least 0.05% by mass and no greater than 0.3% by mass.

### [Surfactant]

Preferably, the ink of the present disclosure further contains a surfactant. The surfactant ensures permeability (wettability) of the ink of the present disclosure to a recording medium. Examples of the surfactant include anionic surfactants, cationic surfactants, and nonionic surfactants. The surfactant is preferably a nonionic surfactant.

Examples of the nonionic surfactants include polyoxyethylene dodecyl ether, polyoxyethylene hexadecyl ether, polyoxyethylene nonylphenyl ether, polyoxyethylene sorbitan monooleate ether, monodecanoyl sucrose, and ethylene oxide adducts of acetylene glycol. A preferable nonionic surfactant is an ethylene oxide adduct of acetylene glycol.

The percentage content of the surfactant in the ink of the present disclosure is preferably at least 0.05% by mass and no greater than 3.0% by mass, and more preferably at least 0.2% by mass and no greater than 1.0% by mass.

### [Additional Component]

The ink of the present disclosure may further contain a known additive (specific examples include a defoaming agent, a solution stabilizer, an anti-drying agent, an antioxidant, a viscosity modifier, a pH adjuster, and an antifungal agent). Preferably, the ink of the present disclosure further contains a defoaming agent. The percentage content of the defoaming agent in the ink of the present disclosure is preferably at least 0.01% by mass and no greater than 0.1% by mass.

### [Ink Production Method]

The ink of the present disclosure can be produced for example by uniformly mixing a pigment dispersion containing the pigment particles, water, and any other components (e.g., a water-soluble organic solvent, a sugar alcohol, and a surfactant) added as necessary using a stirrer. In production of the ink of the present disclosure, uniform mixing of these components may be followed by removal of foreign matter and coarse particles using a filter (e.g., a filter with a pore size of no greater than 5 μm).

### (Pigment Dispersion)

The pigment dispersion is a dispersion containing the pigment particles. The dispersion medium of the pigment dispersion is preferably water. Preferably, the pigment dispersion further contains a defoaming agent.

The percentage content of the pigment in the pigment dispersion is preferably at least 5.0% by mass and no greater than 25.0% by mass, and more preferably at least 10.0% by mass and no greater than 20.0% by mass. The percentage content of specific resin in the pigment dispersion is preferably at least 4.0% by mass and no greater than 20.0% by mass, and more preferably at least 6.0% by mass and no greater than 12.0% by mass. In a case in which the pigment dispersion contains a defoaming agent, the percentage content of the defoaming agent in the pigment dispersion is preferably at least 0.01% by mass and no greater than 0.5% by mass, and more preferably at least 0.05% by mass and no greater than 0.2% by mass.

The pigment dispersion can be prepared by wet dispersion of the pigment, the specific resin, a dispersion medium (e.g., water), and a component added as necessary (e.g., a defoaming agent) using a media type wet disperser. In wet dispersion using a media type wet disperser, small-diameter beads (e.g., beads with a D₅₀ of at least 0.5 mm and no greater than 1.0 mm) can be used as the medium. The material of the beads is not limited particularly, and preferably is a hard material (e.g., glass or zirconia).

In a case in which a pigment dispersion is added in production of the ink of the present disclosure, the ratio of the pigment dispersion to all raw materials of the ink is at least 25.0% by mass and no greater than 60.0% by mass, for example.

### Examples

The following describes Examples of the present disclosure. However, the present disclosure is not limited to Examples below.

### [Specific Resin Synthesis]

### (Specific Resin (R-1))

A stirrer, a nitrogen inlet tube, a condenser, a stirrer bar, and a dripping funnel were set at a four-necked flask. The four-necked flask was used as a reaction vessel. Next, 100.0 g of isopropyl alcohol and 300.0 g of methyl ethyl ketone were added into the reaction vessel. Next, the contents of the reaction vessel were heated to 70° C. (reflux state) under nitrogen gas bubbling. Separately, 60.0 g of styrene, 35.0 g of acrylic acid, 5.0 g of polyethylene glycol acrylate (average number of moles added of ethylene oxide: 4 mol, end group: methyl group), and 0.400 g of azobisisobutyronitrile (AIBN, polymerization initiator) were mixed to yield a monomer solution. The polyethylene glycol acrylate was a compound represented by the aforementioned general formula (1) with R¹ representing a methyl group, R² representing a hydrogen atom, and n representing 4. Next, the monomer solution was dripped into the reaction vessel over 15 minutes with the temperature of the contents of the reaction vessel kept at 70° C. (reflux state). After the dripping, the temperature of the contents of the reaction vessel was kept at 70° C. (reflux state) for 5 hours. Next, the contents of the reaction vessel were depressurized to remove the solvent. Through the above, a specific resin (R-1) was obtained.

### (Specific Resins (R-2) to (R-13))

Specific resins (R-2) to (R-13) were synthesized according to the same method as that for synthesizing the specific resin (R-1) in all aspects other than that the type and ratio of the monomer used were changed as shown below in Table 1.

In Table 1 below, the specific monomer used for synthesis of each of the specific resins (R-1) to (R-13) was polyethylene glycol acrylate or polypropylene glycol acrylate (a compound represented by the aforementioned general formula (1) or (2) with R² representing a hydrogen atom). “EO” in “Polyalkylene oxide structure” indicates that the corresponding specific monomer has a polyethylene oxide structure. Also, “PO” indicates that the corresponding specific monomer has a polypropylene oxide structure. “Number of moles added” indicates an average number (n in general formula (1)) of moles added of ethylene oxide in the polyethylene oxide structure or an average number (m in general formula (2)) of moles added of propylene oxide in the polypropylene oxide structure. “End group” indicates an end group (R¹ in general formula (1)) in the polyethylene oxide structure or an end group (R¹ in general formula (2)) in the polypropylene oxide structure. “C₂₀H₄₁” in “End group” indicates a long-chain alkyl group with a carbon number of 20.

Each Mw of the specific resins (R-1) to (R-13) was measured by the following method. Measurement results are shown below in Table 1. Each Mw of the specific resins (R-1) to (R-13) was measured using a gel permeation chromatography (“HLC-8020GPC”, product of Tosoh Corporation) under the following conditions. A calibration curve was plotted using F-40, F-20, F-4, F-1, A-5000, A-2500, and A-1000 each being TSKgel standard polystyrene produced by Tosoh Corporation, and n-propylbenzene.

### (Conditions for Mass Average Molecular Weight Measurement)

Column: “TSKgel SuperMultipore HZ-H” produced by Tosoh Corporation (semi-micron column with 4.6 mm I.D.×15 cm)
Number of columns: 3
Eluent: Tetrahydrofuran
Flow rate: 0.35 mL/min.
Sample injection amount: 10 μL
Measurement temperature: 40° C.
Detector: IR detector

TABLE 1

| | | | | | | Specific monomer | | | |
|---|---|---|---|---|---|---|---|---|---|
| | | Styrene | Acrylic acid | Other | | | Polyalkylene oxide structure | | |
| | | Amount | Amount | | Amount | Amount | | Number of | |
| | Mw | [wt %] | [wt %] | Type | [wt %] | [wt %] | Type | moles added | End group (R¹) |
| R-1 | 1.1 × 10⁴ | 60 | 35 | — | — | 5 | EO | 4 | Methyl group |
| R-2 | 1.8 × 10⁴ | 69 | 30 | — | — | 1 | PO | 4 | — |
| R-3 | 1.5 × 10⁴ | 55 | 35 | — | — | 10 | EO | 9 | Methyl group |
| R-4 | 2.2 × 10⁴ | 55 | 40 | | — | 5 | EO | 2 | Methyl group |
| R-5 | 0.78 × 10⁴ | 60 | 32 | — | — | 8 | EO | 14 | Methyl group |
| R-6 | 4.0 × 10⁴ | 65 | 34 | — | — | 1 | PO | 2 | Methyl group |
| R-7 | 1.9 × 10⁴ | 60 | 40 | — | — | — | — | — | — |
| R-8 | 3.2 × 10⁴ | 70 | 15 | — | — | 15 | EO | 9 | Methyl group |
| R-9 | 5.5 × 10⁴ | 60 | 35 | — | — | 5 | EO | 4 | C₂₀H₄₁ |
| R-10 | 2.0 × 10⁴ | 50 | 38 | — | — | 12 | EO | 9 | C₂₀H₄₁ |
| R-11 | 2.6 × 10⁴ | 47 | 45 | N-vinyl pyridine | 3 | 5 | EO | 2 | Methyl group |
| R-12 | 1.4 × 10⁴ | 55 | 37 | N-vinyl pyridine | 5 | 3 | PO | 4 | Methyl group |
| R-13 | 1.3 × 10⁴ | 40 | 50 | — | — | 10 | EO | 9 | Methyl group |

### [Pigment Dispersion Preparation]

### (Pigment Dispersion (P-1))

Mixing was carried out of 15.0 parts by mass of a carbon black (“PRINTEX (registered Japanese trademark) 85”, product of Orion Engineered Carbons KK) as a pigment, 10.0 parts by mass of the specific resin (R-1), 0.1 parts by mass of a defoaming agent (“SN-DEFOAMER 1340”, product of SAN NOPCO LIMITED), and 74.9 parts by mass of ion exchange water. The resultant mixture was dispersed (peripheral speed 10 m/sec) for 4 hours using a bead mill (“DYNO-MILL MULTI-LAB”, product of Willy A. Bachofen AG). The medium used in the dispersion treatment was zirconia beads (diameter 0.5 mm). In the dispersion treatment, the filling rate of the medium in a vessel of the bead mill was set at 60% by volume. Furthermore, the treatment temperature (chiller temperature) in the dispersion treatment was set at 10° C. After the medium was removed following the dispersion treatment, the resultant mixture was filtered using a filer with a pore size of 5 μm to remove foreign matter and coarse particles. Through the above, pigment dispersion (P-1) was obtained.

### (Pigment Dispersions (P-2) to (P-13))

Pigment dispersions (P-2) to (P-13) were prepared according to the same method as that for preparing the pigment dispersion (P-1) in all aspects other than that the types and amounts of raw materials used were changed as shown below in Table 2.

Details of the pigments below in Table 2 are as follows.
Printex®85: Carbon black (“PRINTEX (registered Japanese trademark) 85” produced by Orion Engineered Carbons KK)
Printex®80: Carbon black (“PRINTEX (registered Japanese trademark) 80” produced by Orion Engineered Carbons KK)
MOGUL®L: Carbon black (“MOGUL (registered Japanese trademark) L” produced by Cabot Corporation)

TABLE 2

| | Pigment | | Specific resin | | Defoaming agent | Water | Total |
|---|---|---|---|---|---|---|---|
| | Type | % by mass | Type | % by mass | [% by mass] | [% by mass] | [% by mass] |
| P-1 | Printex (R)85 | 15 | R-1 | 10 | 0.1 | Rest | 100.0 |
| P-2 | MOGUL (R)L | 16 | R-2 | 8 | 0.1 | Rest | 100.0 |
| P-3 | Printex (R)80 | 15 | R-3 | 9 | 0.1 | Rest | 100.0 |
| P-4 | Printex (R)80 | 15 | R-4 | 9 | 0.1 | Rest | 100.0 |
| P-5 | Printex (R)85 | 15 | R-5 | 8 | 0.1 | Rest | 100.0 |
| P-6 | Printex (R)80 | 15 | R-6 | 10 | 0.1 | Rest | 100.0 |
| P-7 | MOGUL (R)L | 15 | R-7 | 10 | 0.1 | Rest | 100.0 |
| P-8 | Printex (R)85 | 15 | R-8 | 9 | 0.1 | Rest | 100.0 |
| P-9 | Printex (R)80 | 15 | R-9 | 10 | 0.1 | Rest | 100.0 |
| P-10 | Printex (R)85 | 15 | R-10 | 12 | 0.1 | Rest | 100.0 |
| P-11 | MOGUL (R)L | 16 | R-11 | 10 | 0.1 | Rest | 100.0 |
| P-12 | Printex (R)85 | 15 | R-12 | 9 | 0.1 | Rest | 100.0 |
| P-13 | Printex (R)85 | 15 | R-13 | 9 | 0.1 | Rest | 100.0 |

### <Ink Preparation>

After the raw materials shown below in Tables 3 and 4 were mixed, the resultant mixture was dispersed at a temperature of 25° C. for 20 minutes using a disperser (“HOMOMIXER Model MARKII 2.5”, product of PRIMIX Corporation) at a rotational speed of 3000 rpm. After the dispersion treatment, the resultant mixture was filtered using a filter with a pore size of 5 μm to remove foreign matter and coarse particles. Through the above, inks (pigment concentration: approximately 6.0% by mass) of Examples 1 to 7 and Comparative Examples 1 to 7 were prepared. Note that “Surfactant” in Tables 3 and 4 indicates a surfactant (OLFINE (registered Japanese trademark) E101”, product of Nissin Chemical Industry Co., Ltd.) containing an ethylene oxide adduct of acetylenediol.

TABLE 3

| | | Example | | | | | | |
|---|---|---|---|---|---|---|---|---|
| | | 1 | 2 | 3 | 4 | 5 | 6 | 7 |
| Pigment dispersion | P-1 | 40.1 | — | — | 25.0 | — | — | — |
| | P-2 | — | 38.0 | — | 15.0 | — | — | — |
| | P-3 | — | — | 42.0 | — | — | — | — |
| | P-11 | — | — | — | — | 40 | — | — |
| | P-12 | — | — | — | — | — | 40 | — |
| | P-13 | — | — | — | — | — | — | 40 |

| | | | | | | | |
|---|---|---|---|---|---|---|---|
| 3-Methyl-1,5-pentanediol | 8.9 | — | 7.0 | 8.4 | 8.9 | 8.9 | 8.9 |
| Triethylene glycol monobutyl ether | 8.9 | 6.0 | 3.0 | 8.5 | 8.9 | 8.9 | 8.9 |
| Glycerin | 7.1 | 2.0 | 5.0 | 7.1 | 7.1 | 7.1 | 7.1 |
| 2-Pyrrolidone | 1.2 | 1.2 | 1.2 | 1.2 | 1.2 | 1.2 | 1.2 |
| 1,2-Octanediol | 0.1 | 0.1 | 0.1 | 0.1 | 0.1 | 0.1 | 0.1 |
| Sorbitol | 0.1 | 0.1 | 0.1 | 0.1 | 0.1 | 0.1 | 0.1 |
| 1,3-Propanediol | — | 8.9 | — | — | — | — | — |
| 1,5-Pentanediol | — | 8.9 | 8.0 | — | — | — | — |
| Surfactant | 0.5 | 0.5 | 0.5 | 0.5 | 0.5 | 0.5 | 0.5 |
| Water | 33.1 | 34.3 | 33.1 | 34.1 | 33.2 | 33.2 | 33.2 |
| Total | 100.0 | 100.0 | 100.0 | 100.0 | 100.0 | 100.0 | 100.0 |

TABLE 4

| | | Comparative Example | | | | | | |
|---|---|---|---|---|---|---|---|---|
| | | 1 | 2 | 3 | 4 | 5 | 6 | 7 |
| Pigment | P-4 | 40.0 | — | — | — | — | — | — |
| dispersion | P-5 | — | 42.0 | — | — | — | — | — |
| | P-6 | — | — | 40.0 | — | — | — | — |
| | P-7 | — | — | — | 40.0 | — | — | — |
| | P-8 | — | — | — | — | 40.0 | — | — |
| | P-9 | — | — | — | — | — | 40.0 | — |
| | P-10 | — | — | — | — | — | — | 40.0 |

| | | | | | | | |
|---|---|---|---|---|---|---|---|
| 3-Methyl-1,5-pentanediol | 9.0 | 7.4 | 7.0 | 7.0 | 7.0 | — | 7.0 |
| Triethylene glycol monobutyl | 8.9 | 7.5 | 3.0 | 3.0 | 3.0 | 6.0 | 3.0 |
| ether | | | | | | | |
| Glycerin | 7.1 | 7.1 | 7.0 | 7.0 | 7.0 | 2.8 | 7.0 |
| 2- Pyrrolidone | 1.2 | 1.2 | 1.2 | 1.2 | 1.2 | 1.2 | 1.2 |
| 1,2-Octanediol | 0.1 | 0.1 | 0.1 | 0.1 | 0.1 | 0.1 | 0.1 |
| Sorbitol | 0.1 | 0.1 | 0.1 | 0.1 | 0.1 | 0.1 | 0.1 |
| 1,3-Propanediol | — | — | — | — | — | 7.5 | — |
| 1,5-Pentanediol | — | — | 8.0 | 8.0 | 8.0 | 7.5 | 8.0 |
| Surfactant | 0.5 | 0.5 | 0.5 | 0.5 | 0.5 | 0.5 | 0.5 |
| Water | 33.1 | 34.1 | 33.1 | 33.1 | 33.1 | 34.3 | 33.1 |
| Total | 100.0 | 100.0 | 100.0 | 100.0 | 100.0 | 100.0 | 100.0 |

### [Particle Diameter Distribution Measurement]

With respect to each of the inks of Examples 1 to 7 and Comparative Examples 1 to 7, the particle diameter distribution of the pigment particles was measured. In the measurement, a dilution prepared by diluting an evaluation target (specifically, any of the inks of Examples 1 to 7 and Comparative Examples 1 to 7) with ion exchange water 100 times was used as a sample. Tables 5 and 6 below show the measured 10% cumulative volume particle diameters (D₁₀), 50% cumulative volume particle diameters (D₅₀), and 90% cumulative volume particle diameters (D₉₀).

TABLE 5

| | | Example 1 | Example 2 | Example 3 | Example 4 | Example 5 | Example 6 | Example 7 |
|---|---|---|---|---|---|---|---|---|
| Particle | D₁₀ [nm] | 65 | 75 | 59 | 60 | 52 | 71 | 64 |
| diameter | D₅₀ [nm] | 98 | 108 | 86 | 90 | 97 | 117 | 123 |
| distribution | D₉₀ [nm] | 181 | 201 | 174 | 184 | 186 | 240 | 213 |

TABLE 6

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Particle | D₁₀ [nm] | 76 | 62 | 90 | 73 | 67 | 66 | 77 |
| diameter | | | | | | | | |
| distribution | D₅₀ [nm] | 118 | 95 | 124 | 127 | 102 | 110 | 109 |
| | D₉₀ [nm] | 215 | 159 | 239 | 241 | 204 | 166 | 156 |

### <Evaluation>

With respect to each of the inks of Examples 1 to 7 and Comparative Examples 1 to 7, viscosity, particle diameter change rate, preservation stability, image density of a formed image, and occurrence or non-occurrence of nozzle clogging were evaluated. Evaluation results are shown below in Tables 7 and 8.

### [Viscosity]

The viscosity of the evaluation target (specifically, any of the inks of Examples 1 to 7 and Comparative Examples 1 to 7) at 25° C. was measured using a vibration type viscometer (“VM-IOA-L”, product of Nittetsu Hokkaido Control Systems Co.). The viscosity of each evaluation target was evaluated according to the following criteria.

### (Criteria for Viscosity)

A (good): no greater than 5 mPa-s
B (poor): greater than 5 mPa-s

### [Particle Diameter Change Rate]

The particle diameter distribution of the pigment particles of the evaluation target (specifically, any of the inks of Examples 1 to 7 and Comparative Examples 1 to 7) was measured to obtain a 50% cumulative volume particle diameter (initial D₅₀). Next, the evaluation target was left to stand in a thermostat chamber at 40° C. (heating treatment). The heating treatment was carried out until 40% by mass of the total water content of the evaluation target was lost by evaporation. Next, the particle diameter distribution of the pigment particles of the evaluation target after the heating treatment was measured to obtain a 50% cumulative volume particle diameter (post-heating D₅₀). A particle diameter change rate was calculated using the following equation. The particle diameter change rate of the evaluation target was evaluated according to the following criteria.

$$Particle diameter change rate [ \% ] = 100 \times ( post - heating {D}_{50} - initial {D}_{50} ) / initial {D}_{50}$$

### (Criteria for Particle Diameter Change Rate)

A (good): absolute value of particle diameter change rate of no greater than 10%
B (poor): absolute value of particle diameter change rate of greater than 10%

### [Preservation Stability]

Using the aforementioned vibration type viscometer, a viscosity (initial viscosity V₁) of the evaluation target (specifically, any of the inks of Examples 1 to 7 and Comparative Examples 1 to 7) at 25° C. was measured. Next, approximately 30 g of the evaluation target was charged into a vessel with a capacity of 50 mL and the vessel was sealed. The vessel was placed in a thermostatic oven with the inner temperature thereof set at 60° C., and kept warm for 1 month. Thereafter, the vessel was taken out of the thermostatic oven and left to stand at room temperature for 3 hours. Thereafter, the evaluation target was taken out of the vessel and a viscosity (post-treatment viscosity V₂) thereof at 25° C. was measured using the vibration type viscometer. A viscosity change rate [%] was calculated based on the initial viscosity V₁ and the post-treatment viscosity V₂ using the following equation. The calculated viscosity change rate was taken to be an evaluation value for preservation stability of the ink being the evaluation target. Preservation stability of the ink was evaluated according to the following criteria.

$$Viscosity change rate [ \% ] = 100 \times ( {V}_{1} - {V}_{2} ) / {V}_{1}$$

### (Criteria for Preservation Stability)

A (good): absolute value of viscosity change rate of no greater than 5%
B (poor): absolute value of viscosity change rate of greater than 5%

### [Evaluation Apparatus]

In the following evaluations, an inkjet recording apparatus (prototype produced by KYOCERA Document Solutions Inc.) provided with a recording head of line scan type was used as an evaluation apparatus. The evaluation target (specifically any of the inks of Examples 1 to 7 and Comparative Examples 1 to 7) was loaded in an ink tank of the evaluation apparatus.

### [Image Density]

In evaluation of image density, A4-size plain paper copier (PPC) paper (“C²”, product of FUJIFILM Business Innovation Corp.) was used as evaluation paper. A solid image (printing rate 100%) was formed on a sheet of the evaluation paper using the evaluation apparatus in an environment at a temperature of 25° C. and a relative humidity of 50%. In the solid image formation, the evaluation apparatus was set so that the volume per one drop of the ink ejected from the recording head was 11 pL. Next, the reflection density (ID: image density) of the solid image was measured using a portable reflection densitometer (“RD-19”, product of X-Rite Inc.). In detail, each reflection density of randomly selected 10 locations on the solid image was measured. Thereafter, the average value of the measurement values of the reflection densities at the 10 locations was taken to be an evaluation value (ID) for image density. Image density was evaluated according to the following criteria.

### (Criteria for Image Density)

A (good): ID of at least 1.15
B (poor): ID of less than 1.15

### [Nozzle Clogging]

In evaluation of nozzle clogging, A4-size PPC paper (“C²”, product of FUJIFILM Business Innovation Corp.) was used as evaluation paper. A solid image (printing rate 100%) with a size of 150 mm×200 mm was consecutively printed on 100 sheets of the evaluation paper using the evaluation apparatus in an environment at a temperature of 25° C. and a relative humidity of 50%. Next, the evaluation target was purged from the recording head of the evaluation apparatus. Next, an ink ejection surface of the recording head of the evaluation apparatus was wiped to clean the recording head. In the following, the operation of cleaning the recording head by purging and wiping may be referred to as cleaning treatment. Next, a nozzle check pattern image was formed on a sheet of the evaluation paper using the evaluation apparatus. As a result, the evaluation target was ejected from all nozzles (the number of non-ejection nozzles is 0) regardless of which evaluation target was used. Next, the cleaning treatment was carried out again on the recording head. Next, the evaluation apparatus was left to stand for 7 days with the recording head uncapped. Next, the cleaning treatment was carried out again on the recording head. Next, the nozzle check pattern image (evaluation image) was formed on a sheet of the evaluation paper using the evaluation apparatus. The evaluation image was observed and a ratio of the number of non-ejection nozzles to all the nozzles (7968 nozzles) was calculated. The calculated ratio of the number of non-ejection nozzles was taken to be an evaluation value for nozzle clogging. Whether or not the evaluation target has caused nozzle clogging was evaluated according to the following criteria.

### (Criteria for Nozzle Clogging)

A (good): evaluation value of less than 10%
B (poor): evaluation value of at least 10%

TABLE 7

| | | Examples 1 | Examples 2 | Examples 3 | Examples 4 | Examples 5 | Examples 6 | Examples 7 |
|---|---|---|---|---|---|---|---|---|
| Viscosity | mPa · s | 4.5 | 4.0 | 4.5 | 4.0 | 4.4 | 3.8 | 4.1 |
| | Rating | A | A | A | A | A | A | A |
| Particle diameter | % | −5 | 9 | 1 | 7 | −3 | −6 | 4 |
| change rate | Rating | A | A | A | A | A | A | A |
| Preservation | Evaluation value [%] | 3.8 | 3.4 | 4.5 | 4.2 | 4.8 | 1.2 | 4.4 |
| stability | Rating | A | A | A | A | A | A | A |
| Image density | Evaluation value | 1.21 | 1.20 | 1.17 | 1.18 | 1.19 | 1.17 | 1.20 |
| | Rating | A | A | A | A | A | A | A |
| Nozzle clogging | Evaluation value [%] | 8 | 7 | 8 | 9 | 5 | 8 | 5 |
| | Rating | A | A | A | A | A | A | A |

TABLE 8

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Viscosity | mPa · s | 4.0 | 3.6 | 4.8 | 4.3 | 4.5 | 7.5 | 8.0 |
| | Rating | A | A | A | A | A | B | B |
| Particle diameter | % | 32 | −18 | 9 | 44 | 9 | 11 | 8 |
| change rate | Rating | B | B | A | B | A | B | A |
| Preservation | Evaluation | 11.5 | 9.0 | 6.0 | 19.0 | 4.8 | 20.0 | 18.0 |
| stability | value [%] | | | | | | | |
| | Rating | B | B | B | B | A | B | B |
| Image density | Evaluation | 1.17 | 1.08 | 1.18 | 1.17 | 1.07 | 1.16 | 1.11 |
| | value | | | | | | | |
| | Rating | A | B | A | A | B | A | B |
| Nozzle clogging | Evaluation | 13 | 12 | 11 | 16 | 9 | 19 | 7 |
| | value [%] | | | | | | | |
| | Rating | B | B | B | B | A | B | A |

As shown in Tables 1 to 8, each of the inks of Examples 1 to 7 contained pigment particles and water. The pigment particles contained a pigment and a specific resin. The specific resin included a first repeating unit derived from a specific monomer. The specific monomer was nonionic and had a group represented by the aforementioned general formula (A) or (B). Of all repeating units included in the specific resin, the first repeating unit had a percentage content of at least 0.5% by mass and no greater than 11% by mass. The inks of Examples 1 to 7 were excellent in preservation stability, had moderate viscosity, formed images with desired image density, and inhibited occurrence of nozzle clogging.

By contrast, in the inks of Comparative Examples 1 to 3, the average number of moles added of ethylene oxide was less than 3 or greater than 9 in the polyethylene oxide structure of the group (A) of the first repeating unit in the specific resin. The inks of Comparative Examples 1 to 3 were poor in at least one of preservation stability, image density, and nozzle clogging.

The specific resin of the ink of Comparative Example 4 did not include the first repeating unit. The ink of Comparative Example 4 was poor in preservation stability and nozzle clogging.

The content ratio of the first repeating unit in the specific resin of the ink of Comparative Example 5 was greater than 11% by mass. The ink of Comparative Example 5 was poor in image density.

The group (A) of the first repeating unit in the specific resin of each of the inks of Comparative Examples 6 and 7 had a long-chain alkyl group. In addition, the content ratio of the first repeating unit in the specific resin of the ink of Comparative Example 7 was greater than 11% by mass. The inks of Comparative Examples 6 and 7 were poor in at least one of viscosity, preservation stability, and nozzle clogging.

What is claimed is:

1. An inkjet ink comprising:
pigment particles; and
water, wherein
the pigment particles contain a pigment and a specific resin,
the specific resin includes a first repeating unit derived from a specific monomer,
the specific monomer is nonionic and has a group represented by general formula (A) or (B) below, and
of all repeating units included in the specific resin, the first repeating unit has a percentage content of at least 0.5% by mass and no greater than 11% by mass, 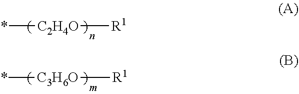
where in the general formulas (A) and (B), R¹ represents a hydrogen atom or an alkyl group with a carbon number of at least 1 and no greater than 5, n and m each represent, independently of one another, a number of at least 3 and no greater than 9, and * represents a bond.

2. The inkjet ink according to claim 1, wherein
in dynamic light scattering particle diameter distribution measurement,
the pigment particles have a 10% cumulative volume particle diameter (D₁₀) of at least 50 nm and no greater than 80 nm,
the pigment particles have a 50% cumulative volume particle diameter (D₅₀) of at least 80 nm and no greater than 130 nm, and
the pigment particles have a 90% cumulative volume particle diameter (D₉₀) of at least 150 nm and no greater than 250 nm.

3. The inkjet ink according to claim 1, wherein
the specific monomer is represented by general formula (1) or (2) below: 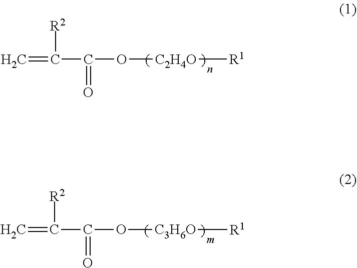
where in the general formulas (1) and (2), R¹, n, and m are the same as defined for those in the general formulas (A) and (B) and R² represents a hydrogen atom or a methyl group.

4. The inkjet ink according to claim 1, wherein
the specific resin further includes a second repeating unit derived from (meth)acrylic acid, and
of all the repeating units included in the specific resin, the second repeating unit has a percentage content of at least 20% by mass and no greater than 45% by mass.
